(19) United States
(12) Patent Application Publication
(10) Pub. No.: US 2016/0015036 A1
(43) Pub. Date: Jan. 21, 2016

(54) Methods and apparatuses related to pre- and post-dip teat treatment in milking facilities

(71) Applicant: Aqua Access LLC, Albuquerque, NM (US)

(72) Inventor: George Bajszar, Colorado Springs, CO (US)

(21) Appl. No.: 14/854,320

(22) Filed: Sep. 15, 2015

Related U.S. Application Data
(63) Continuation of application No. PCT/US2014/030722, filed on Mar. 17, 2014.
(60) Provisional application No. 61/812,578, filed on Apr. 16, 2013.
(60) Provisional application No. 61/803,070, filed on Mar. 18, 2013.
(60) Provisional application No. 61/816,702, filed on Apr. 27, 2013.

(51) Int. Cl. A01N 59/00; A01N 25/04; A01N 25/24

(52) U.S. Cl. CPC A01N 59/00; A01N 25/24; A01N 25/04

(57) ABSTRACT

A novel inexpensive post-dip formulation for the use of chlorine-based post-dip disinfectant. The present invention provides a new pre-dip or post-dip formulation with the following properties: Inexpensive; Easy to produce and mix at the site of application from readily available components; Components which can be delivered in dry form for reduced bulk; Harmless, non-irritating for the teat skin and for the skin of the milkers; Highly effective bactericide in pre and post-dip solutions for mastitis prevention; Yields only environmentally friendly byproducts.

The present invention claims priority as a continuation of PCT/US2014/030722, filed 17 Mar. 2014, and thence to its priority applications U.S. provisional applications 61/812,578, filed Apr. 16, 2013; 61/803,070, filed Mar. 18, 2013; and 61/816,702, filed Apr. 27, 2013. Each of the preceding is incorporated herein by reference.

### BACKGROUND

In the last four decades pre- and postmilking teat antisepses became routine procedures for bovine mastitis control and prevention of intramammary infections (IMI) in dairy cows. These procedures involve dipping teats of dairy cows before and after milking with an appropriate germicidal preparation to reduce teat skin colonization and minimize contamination with mastitis-causing bacteria and penetration into the teat canal. Particularly, postmilking teat antisepsis is regarded as the single most effective practice for the prevention of mastitis caused by the contagious pathogens such as Staphylococcus aureus, Streptococcus agalactiae, Mycoplasma bovis, and Corynebacterium bovis. Premilking teat sanitization has been also widely adopted to minimize the number of potential intramammary pathogens on teat ends prior to attachment of milking machines; these pathogens include the environmental bacteria such as Escherichia coli, Streptococcus uberis and Klebsiella pneumoniae.

The internationally accepted standards for antimicrobial activity testing for teat dips are the ICS 71.100.35 (EN 1656:2009 E) European Standard, approved by CEN on 20 Sep. 2009 and the AOAC Official Method 960.09 for testing germicidal and detergent sanitizing action of disinfectants, published in 1995 in AOAC Official Methods of Analysis (Chapter 6, p. 9-11). These methods can be used in combination with various experimental challenge models and natural exposure models for testing the microbiocidal activity of teat dips. Nevertheless, at present, there is no U. S. regulatory agency that requires efficacy testing prior to marketing a teat dip product. Thus, many teat disinfectants have not been tested for their effectiveness in reducing new cases of mastitis in dairy cows.

The most commonly used chemical disinfectants in the dairy industry include a variety of iodophor (iodine-releasing) complexes, chlorhexidine, and chlorine (as sodium hypochlorite, nisin and others, as described in the following paragraphs.

Iodophor Complexes.

Iodine is a broad-spectrum germicide, which is fast acting and effective against all mastitis-causing bacteria as well as fungi, viruses, and bacterial spores. This element is microbiocidal due to the oxidizing reaction between iodine and organic matter. Iodine is dissolved in water by complexing with water-soluble detergents or surfactants, and this resulting solution is referred to as an iodophor. Nearly all of the available iodine in the iodophor is present in the complexed but unbound form, and, as such, is not antimicrobial. The uncomplexed form is referred to as free iodine (usually 6 to 12 ppm) and provides the antimicrobial activity by oxidizing microorganisms.

Chlorhexidine is a rapidly acting, nonirritating germicide composed of biguanide compounds. This germicide is effective against most Gram-positive and Gram-negative bacteria as well as some viruses by precipitating cytoplasmic proteins and macromolecules. However, if heavily contaminated, Serratia species and Pseudomonas species can survive in chlorhexidine-based products and serve as potential mastitis pathogens. Teat sanitizers utilizing this germicide contain between 0.35% to 0.55% chlorhexidine gluconate or acetate as well as humectants and emollients to minimize irritation. Chlorhexidine sanitizers adhere well to teat skin, provide antimicrobial activity over time, and do not have deleterious effects on teat skin.

Sodium Hypochlorite (Bleach).

In general, hypochlorite is superior to most environmental disinfectants. Hypochlorite has been demonstrated to effectively reduce the level of contamination of experimentally inoculated environmental surfaces. For example, a solution containing 100 ppm hypochlorite applied for 1 min. killed 10⁶ E. coli cells. Although hypochlorite solutions are not marketed as teat dips and their use violates federal regulations, they continue to be used both as pre- and postmilking teat dips. In practice, to be effective without damaging teat skin, commercial products must be diluted 4.0% (40,000 ppm) hypochlorite. Emollients and glycerol can't be included because of associated problems of oxidant demand leading to rapid degradation of free available chlorine (FAC). When such high concentrations of sodium hypochlorite solutions are used, irritation to the teat skin as well as to milkers' hands is observed; although usually mild, but the condition is transitory, and teat condition returns to normal only with a few weeks. Use of such products at such concentrations is not recommended. These problems with hypochlorite can be circumvented by using relatively low concentrations of hypochlorite (100-400 ppm), generated by salt-brine electrolysis on the site of application, incorporated in a gelling agent mixture that has no oxidant demand and shows similar properties in post-dip application as the commonly used iodophor solutions.

The Use of OSG MOS for Post-Dip Disinfection.

CDC recommends that chlorine solutions used in environmental disinfection be prepared fresh daily. There are data demonstrating low stability of chlorine during storage for commercial grade bleach at 12.5% concentration. For example, the concentration of FAC at 30 days is only approximately 40% of initial values when a 1:100 dilution is stored. It appears that users should prepare their initial dilution at twice the concentration of the chlorine level desired following a few weeks of storage. For example, if one wished to have a solution containing 500 ppm of available chlorine on day 30, one would initially prepare a solution containing 1,000 ppm of chlorine.

Description of Invention

Pre dip solutions generally do not have an emollient or a gelling agent. Pre dips generally comprise an oxidant, a surfactant, and an indicating agent such as a dye. They are used as a pre-wash for the teats to clean them before milking. However, pre-dips can include an emollient in the winter to act as an antifreeze and help avoid skin irritation. Post dip solutions do not normally include a surfactant. Post dip solutions generally include an oxidant, a gelling agent, an emollient, and a dye. The amount of emollient varies summer (less) to winter (more). Both pre and post dip solutions generally always include a dye.

On-site generated mixed oxidant (OSG MOS) can be prepared instantly from salt brine in a simple and inexpensive electrolytic process. These chlorine-based oxidants generated at the site of application are not only more potent disinfectants than bleach (when used at the same FAC concentrations), but also inherently solve the problems of degrading chlorine (hypochlorite) since they are produced at the time of use. These on-site solutions are typically generated at 0.4% to 0.8% concentrations. Also, since the degradation of hypochlorite solutions is a ratio of the cube of the initial concentration, the rate of degradation of on-site generated solution is much slower than commercial grade bleach at 12.5%.

The present invention demonstrates that dilute solutions of sodium hypochlorite (1,200 ppm or less FAC, for less than one minute contact time in pre-dip solutions) and even less FAC in viscous surface-adherent post-dip solutions, in which the disinfectant should be active for several hours, 200-300 ppm FAC was sufficient to achieve the required level of disinfection; i.e., 6-log inactivation of Escherichia coli and of Staphylococcus aureus was achieved in 30 seconds (Appendix 1). OSG MOS is even more effective in reducing the levels of environmental contamination with viruses than dilute solutions of bleach.

A novel inexpensive post-dip formulation for the use of chlorine-based post-dip disinfectant. The present invention provides a new post-dip formulation with the following properties:

Inexpensive;

Easy to produce and mix at the site of application from readily available components;

Harmless, non-irritating for the teat skin and for the skin of the milkers;

Highly effective bactericide in post-dip solutions for mastitis prevention;

Yields only environmentally friendly byproducts.

A gelling agent such as a synthetic layered silicate is suitable for use in the present invention as a specialty inorganic additive and a colloidal rheology modifier for post-dip formulation. Si₈(Mg_{5.5}Li_{0.4})H₄O₂₄Na_{0.7}, marketed as Laponite, is an example of such an agent, and is added to the formulation of many waterborne products such as surface coatings, household cleaners and personal care products and cosmetics. In the present invention, it imparts thixotropic, shear sensitive viscosity, and improves stability and syneresis control of non-newtonian colloids, such as those desired for post-dip solutions. It is non-carcinogenic, skin-friendly, inexpensive and environmentally green. Laponite is widely used as a gelling agent in the cosmetic industry. See, e.g., Neumann, B. S. and K. G. Sansom. 1970, incorporated herein by reference. Laponite gel as a synthetic inorganic gelling agent for aqueous solutions of polar organic compounds. J. Soc. Cosmetic Chemists 21:237-258, incorporated herein by reference. In the example embodiments described below, Laponite is used as a gelling agent, but other gelling agents with similar characteristics can also be suitable.

The present invention demonstrates the applicability of Laponite RD (a product of Southern Clay, Inc., Gonzales, Tex.) in the development of novel post-dip disinfectant formulations using free chlorine.

In some example embodiments, Laponite is used as a gelling agent with an emollient. In some embodiments, lanolin is used as an emollient. In some embodiments, glycerol (also known as glycerin or glycerine) is used as an emollient. In some embodiments, a spray gun is used to mix the dip just prior to application; the Laponite and emollient is supplied to a first path of the spray gun, and a mixed oxidant disinfectant is supplied to a second path. The two paths are mixed near the application tip of the spray gun. This approach prevents the oxidant from reacting with the emollient prematurely. Mixed at the tip, the Laponite appears to bind with the mixed oxidant and dramatically slows down the reaction of the emollient with the oxidant. The solution in each path comprises an easily pumped liquid. When mixed, a gel is formed which can be sprayed on the teat. The gel can be non-Newtonian, such that it does not drip, facilitating the gel retention on the teat for sufficient time to kill pathogens (e.g., mastitis) until the sphincter on the teat closes (typically 30-45 minutes).

### BRIEF DESCRIPTION OF THE DRAWINGS

FIG. 1 is an illustration of a gelling agent concentration test.

FIG. 2 is an illustration of a pH test for colloid stability.

FIG. 3 is an illustration of a test of colloid stability of GA at various FAC concentrations.

FIG. 4 is an illustration of a test for bacteriocidal activity.

FIG. 5 is an illustration of results of low FAC tests.

FIG. 6 is an illustration of the results of intermediate FAC tests.

FIG. 7 is an illustration of the results of intermediate FAC tests.

FIG. 8 is an illustration of the results of high FAC tests.

FIG. 9 is an illustration of the results of high FAC tests.

FIG. 10 is a mixing guide for Pre-Dip solutions with FD&C Blue No. 1 or Orcozine Methylene Blue 2B (OMB-2B) dyes.

FIG. 11 is a mixing guide for Post-Dip mixtures with FD&C Blue No. 1 or Orcozine Methylene Blue 2B (OMB-2B) dyes.

FIG. 12 presents information and structure relative to the mixed solutions.

FIG. 13 is an illustration of the time course of FAC quenching in post-dip and pre-dip solutions in Test #1.

FIG. 14 is chart of the time course of FAC quenching in post-dip and pre-dip solutions in Test #1.

FIG. 15 is an illustration of the time course of FAC quenching in post-dip and pre-dip solutions in Test #2.

FIG. 16 is chart of the time course of FAC quenching in post-dip and pre-dip solutions in Test #2.

FIG. 17 presents the results for E. coli in a Bactericide Activity Test for the New Post Dip formulation containing 2% PEG75-lanolin and FD&C Blue No. 1 dye.

FIG. 18 presents the results for S. aureus in a Bactericide Activity Test for the New Post Dip formulation containing 2% PEG75-lanolin and FD&C Blue No. 1 dye.

FIG. 19 presents the results for E. coli in a Bactericide Activity Test for the New Post Dip formulation containing 2% PEG75-lanolin and Orcozine Methylene Blue B2.

FIG. 20 presents the results for S. aureus in a Bactericide Activity Test for the New Post Dip formulation containing 2% PEG75-lanolin and Orcozine Methylene Blue B2.

FIG. 21 presents the results for E. coli in a Bactericide Activity Test for the New Pre Dip formulation.

FIG. 22 presents the results for S. aureus in a Bactericide Activity Test for the New Pre Dip formulation.

### MODES FOR CARRYING OUT THE INVENTION AND INDUSTRIAL APPLICABILITY

### Example Embodiment

An example embodiment of the present invention was prepared and tested as described herein. A gelling agent concentration test was performed to establish working concentration and mixing procedures for gelling agent (GA) in water to be used as a base medium for post-dip treatment. The results are shown in FIG. 1.

A hard water test was performed to assess GA stability. Solution A was prepared by dissolving 1.98 g magnesium chloride (MgCl₂) and 4.624 g calcium chloride (CaCl₂) in water and diluting to 100 mL. Solution B was prepared by dissolving 3.5 g sodium bicarbonate (NaHCO₃) in water and diluting to 100 mL. The test was performed by adding 6 mL of Solution A to 700 mL DI water, then adding 8 mL of Solution B and filling up to 1 L with water. The pH should be 7.0. The results indicated that the gelling agent forms a stable colloidal gel in hard water at gelling agent concentrations of 2%, 2.5%, 3%, and 4%.

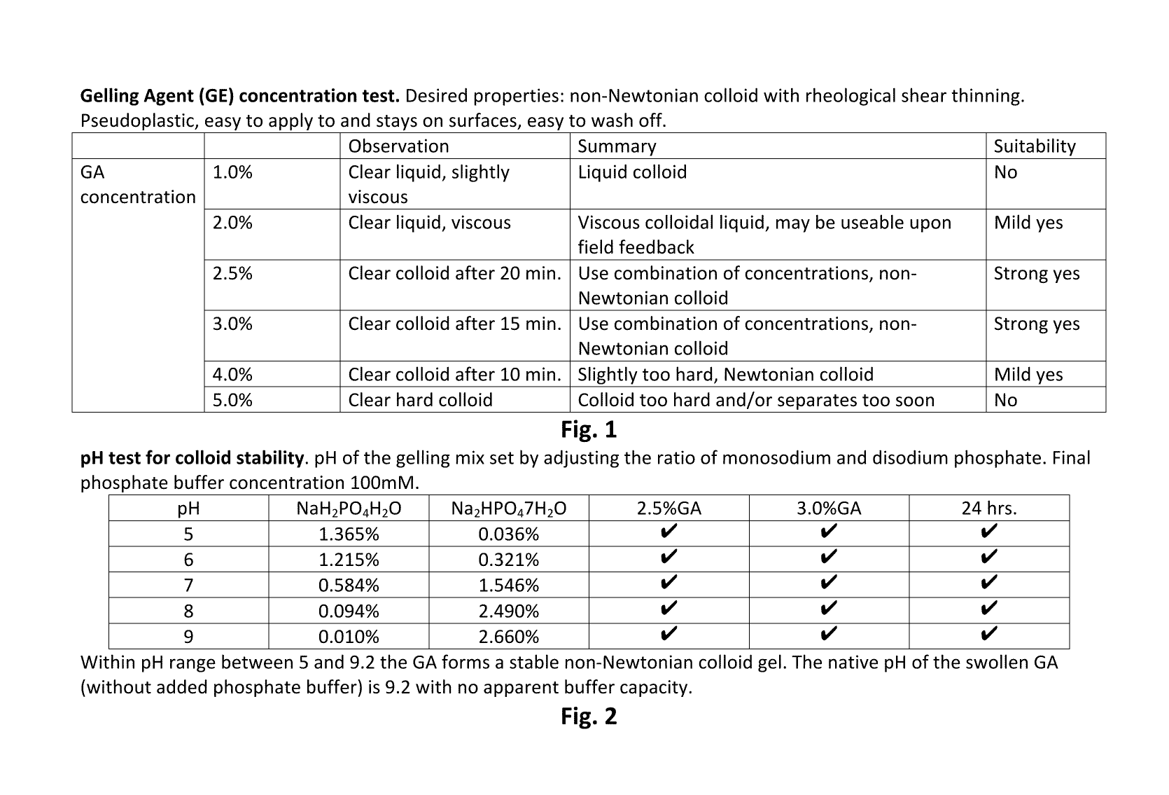

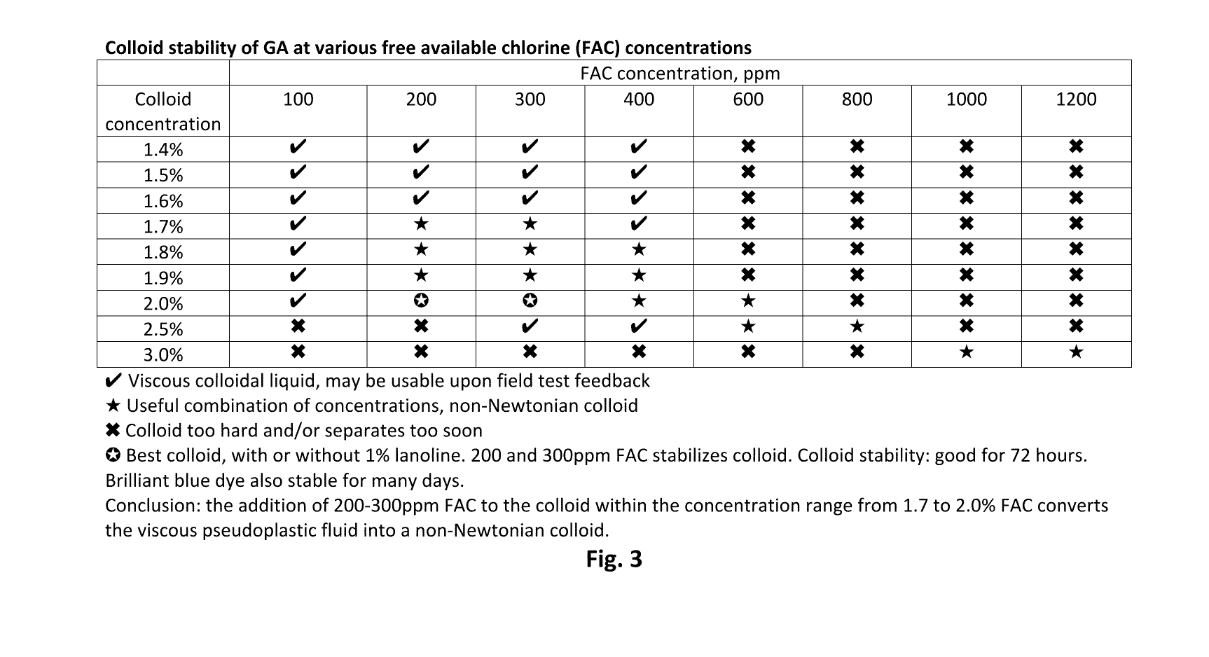

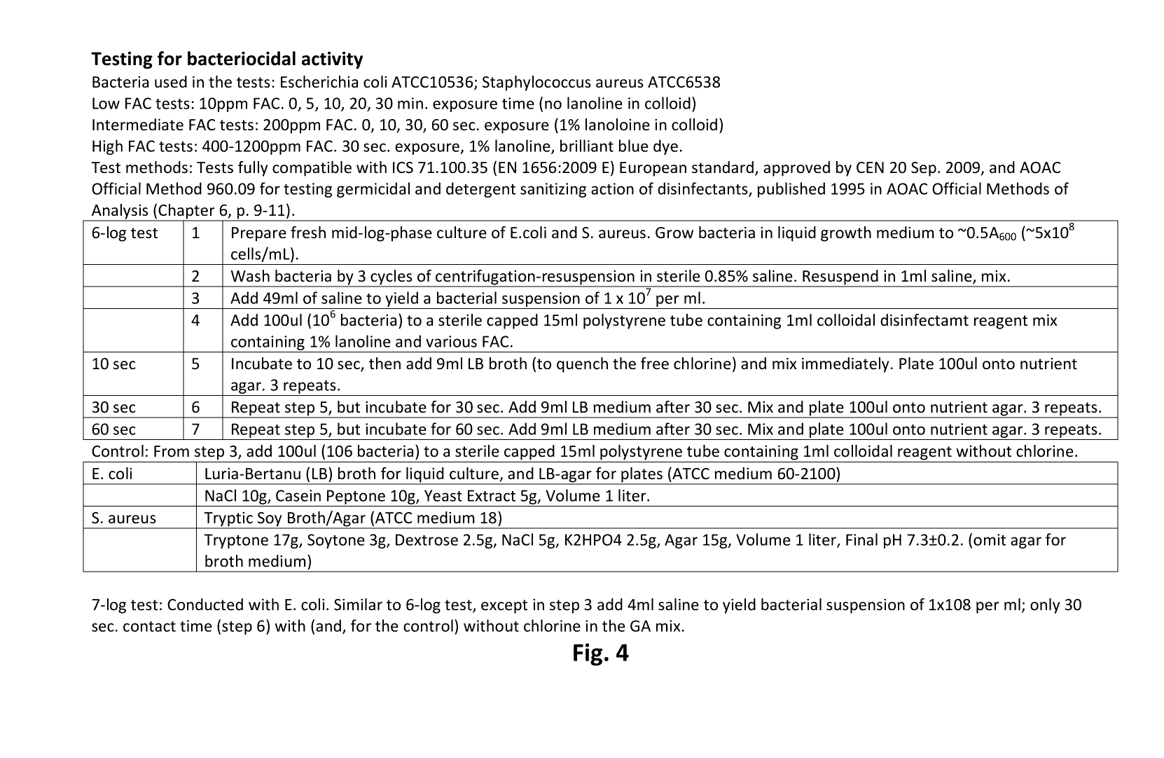

A pH test was performed to assess colloidal stability. The results are shown in FIG. 2. Colloid stability of GA at various free available chlorine (FAC) concentrations was assessed. The results are shown in FIG. 3.

A colloid stability test over time of storage and mixing was performed. GA concentrations of 1.8% and 2.0% were tested, with 200 ppm and 300 ppm FAC added from mixed oxidant solution generated by salt brine electrolysis. The results indicated that the colloid stays stable upon storage with or without constant mixing for 72 hours. High concentrations of FAC were detected at 24 hrs., 48 hrs., and 72 hrs. after storage/mixing.

An electrolyte tolerance test was performed. The test comprises 2% GA mixed with water, and NaCl added at various final concentrations and mixed. Colloid stability was observed visually. This test was indicated because sodium hypochlorite solutions contain various concentrations of NaCl. The NaCl concentrations were 1.0 g/L, 5.0 g/L, 10 g/L, and 20 g/L. The results indicated that the colloid is stable in the presence of all the tested NaCl concentrations. Some liquid separation was seen as 20 g/L NaCl without mixing. The stability of the colloid is good at up to 20 g/L NaCl and in the present of 200 ppm and 300 ppm FAC. Note that the solutions with 200-300 ppm FAC may contain up to 0.5 g/L NaCl.

Colloid mixing with various concentrations of lanoline and milk was tested. GA concentrations of 2% and 2.5% were tested. Addition of 1-2% whole mile was acceptable. The GA mix visibly remained in colloid. Addition of 1-2% lanolin was acceptable. The GA mix visibly remained in colloid. It was important that the milk or lanoline additives were mixed after the colloid was formed in water. Upon adding higher concentration of milk (6-10%) the colloid collapsed. Mixing with 1% lanoline on a rotary carousel mixer required 1 hour for complete visible mixing. Mixing 10% lanoline into the colloid was difficult because of a lack of proper emulsifying techniques. Moderate heating (up to 80° C.) did not help in mixing, but did not affect the colloid state.

Colloid-based disinfectant mixing procedures were established as follows. Step 1—Mix 2 g GA into 90 mL of water, leave with constant slow mixing for 1 hour. Step 2—Generate chlorine-based oxidant by salt brine electrolysis. Measure FAC concentration by the Hach DPD technique. Step 3—Dilute free chlorine solution from fresh electrolyzed brine solution. Final FAC concentration to be 200 ppm or 300 ppm. Step 4—Add 1 g of pure lanolin (with no additives), fill up the volume to 100 mL. Mix with slow stirring or on a rotary carousel for another hour. If needed, add Brilliant Blue (food-grade) dye during the last mixing. Ready. Store at ambient temperature for up to 48 hours or 72 hours.

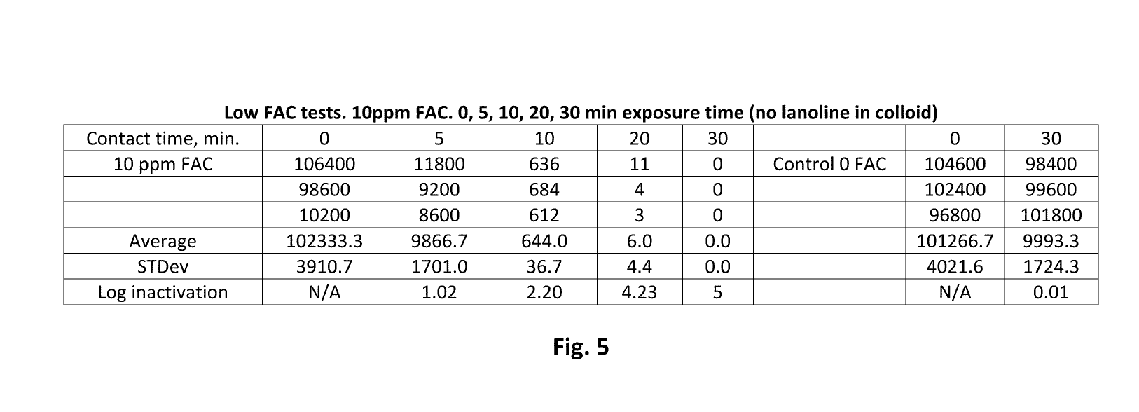

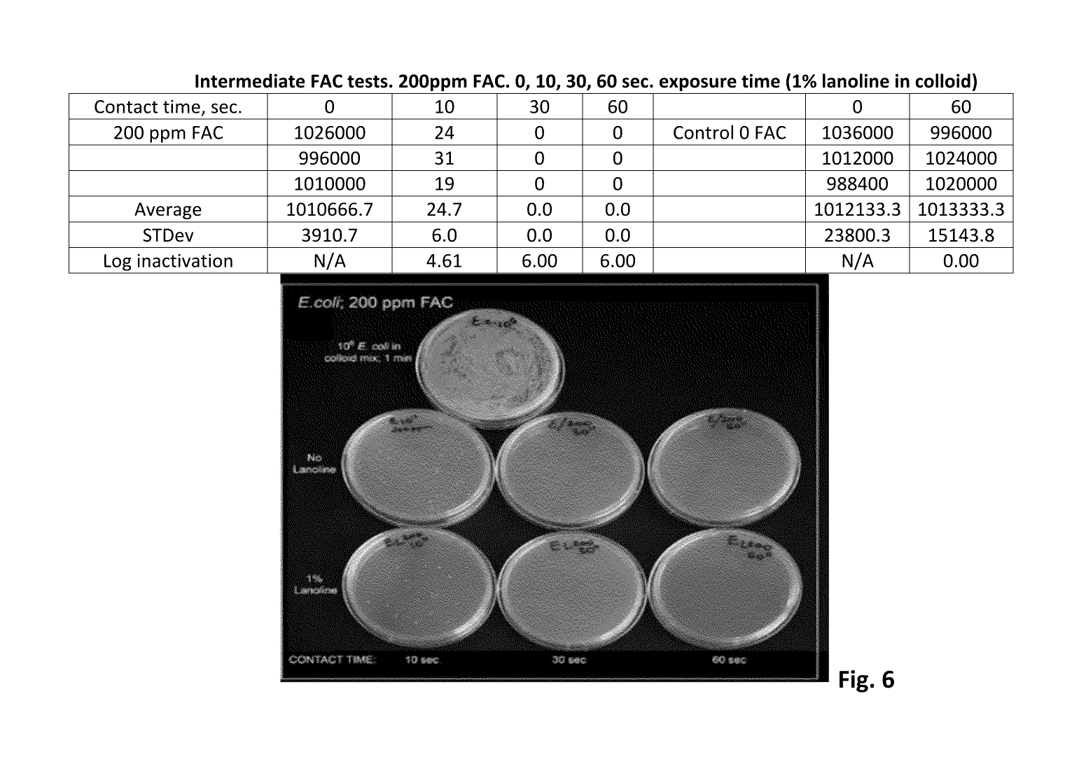

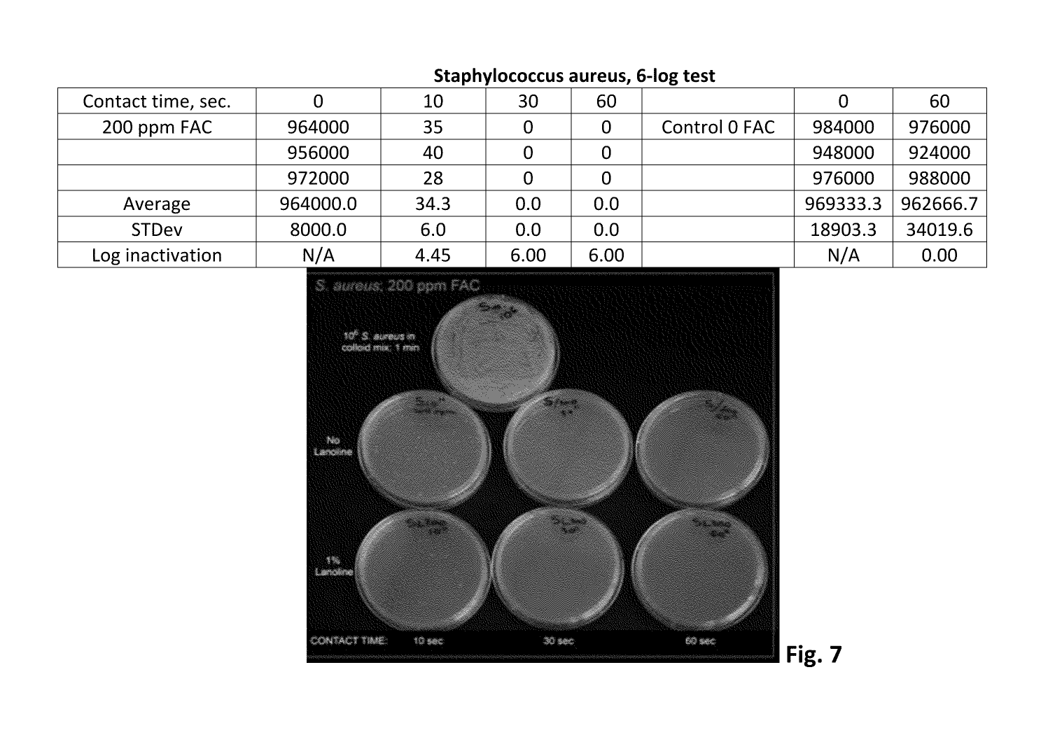

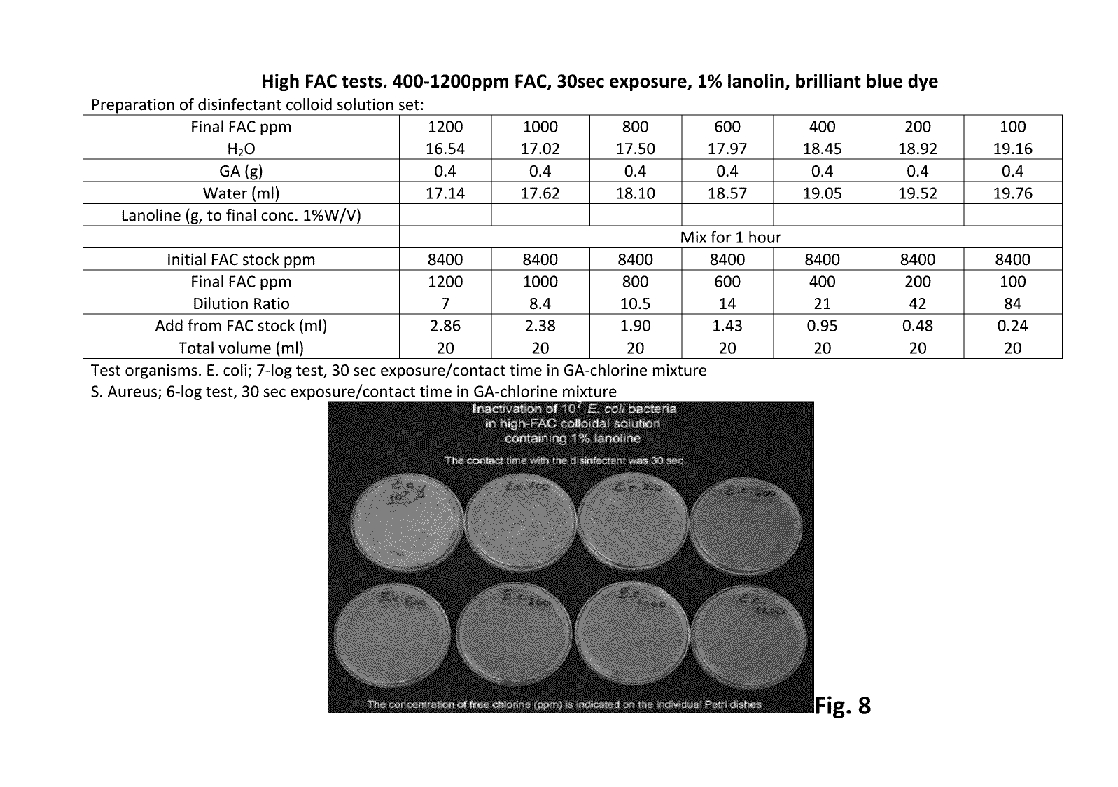

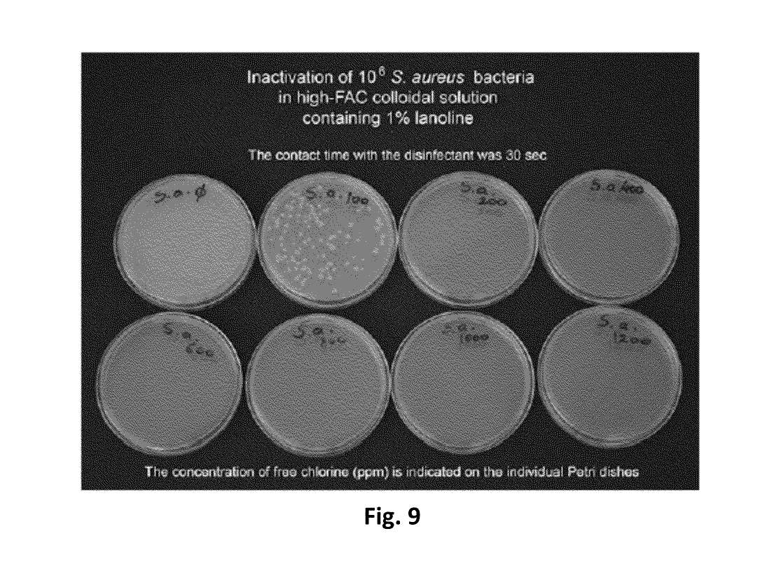

The test methods used in bacteriocidal activity tests are shown in FIG. 4, with the results shown in FIG. 5-9. The results show that, in the colloidal disinfectant mix to be used as a post-dip solution, 200 ppm free chlorine is sufficient for 6-log inactivation of the test bacteria in 30 seconds. Also, 400 ppm FAC in the disinfectant colloid mix causes 7-log inactivation of E. coli, and 200 ppm FAC is sufficient for 6-log inactivation of S. aures. Higher FAC concentrations can be useful in pre-dip solutions for teat wash. 200-300 ppm FAC, which holds for a long time upon storage, can be sufficient for post-dip solutions. Note that the tests were performed under controlled laboratory conditions. Field test data might support the data, or might indicate that higher FAC concentrations are necessary.

### Example Embodiment

An example embodiment of the present invention is described below. A procedure for preparation of a post-dip mixture can be:

Prepare a 4% solution of Laponite RD in tap water. After adding the Laponite powder to the water, mix immediately vigorously for 30-40 sec. Even distribution of the Laponite can be important to best performance. Transparent colloid can form within 15-20 min.

Leave the Laponite suspension to complete colloid formation for 8-12 hours (e.g., overnight).

Calculate the final volume of the post-dip formulation.

The final concentration of the components are approximately as follows:

a. Laponite RD: 1.0-1.4%, depending on the desired final thickness of the post-dip solution

b. Glycerol: 20-40%, depending on the practice of the milking facility

c. Chlorine-based Mixed Oxidant Solution (MOS): 1200-1300 mg/L (ppm)

d. Water (volume is calculated from list a. through c. above)

Add the needed volume of water to the Laponite RD colloid. Mix thoroughly.

Add the needed volume of glycerol. Mix well for 1-2 min. Note: thorough mixing can be important to break up dense colloid fragments.

Add a dye, e.g., a brilliant blue dye, to a desired density. As an example, 1 drop per 10 mL colloid from commercial Assorted Food Colors Kit (Kroeger).

If needed, at this stage emollients, such as lanoline, can be added. Add pure lanoline as needed. Surfactants can produce undesirable results. Longer slow mixing can be effective for the lanoline to emulsify evenly.

The mixture is a physically stable soft gel, for which the “expiration date” is determined only by its vulnerability to microbiological contamination.

Before use for post-dip teat disinfection add MOS to the final desired volume. It is assumed that mixed oxidant solution (MOS) is generated at the site of use by salt brine electrolysis. An example setup is shown below for the preparation of 1 gallon of post-dip mix:

| | | Final concentration |
|---|---|---|
| Water | ½ gallon | |
| Laponite RD | 1/10 lb (45.36 g) | 1.2% (w/vol) |
| Mix well! | | |
| Glycerol | 0.86 liter | 23% (vol/vol) |
| Add Brilliant Blue dye, mix | | |
| well. Store until use. | | |
| Add MOS | 1 liter (of ~5,400 ppm) | ~1,400 ppm |

Example Embodiment Incorporating Application Indicators.

In some applications, it can be important to include a detectable indication that the agent has been applied to the teat. For example, an inspector can be required to verify that the agent ahs been applied, or an automated inspection system can be employed to verify application. Preferably, the indication is inseparable from the post-dip agent itself, so that presence of the indicating agent correlates with application of the post-dip agent. Post-dip solutions like those described herein can further comprise an indicating agent such as an agent that is detectable by electromagnetic sensors, fluorescence sensors, infrared sensors, or visible light sensors. As a specific example, a blue dye can be included in the post-dip solution to facilitate human inspection. The dye can be such that it does not oxidize or otherwise wear off or fade until sufficient time has been allowed for inspection. The dye can further be such that it does not settle out or otherwise separate from the post-dip solution. Preferably, the dye is relatively inexpensive. An example embodiment including suitable dyes was prepared and evaluated as set forth below.

The protocol used is the European Standard EN1656:2009: Chemical disinfectants and antiseptics—Quantitative suspension test for the evaluation of bactericidal activity of chemical disinfectants and antiseptics used in the veterinary area—Test method and requirements. Execution of this Protocol has been conducted according to the instructions on the procedures by Udder Health Systems, Meridian, Id. The disinfectant is aqueous free available chlorine (FAC) generated at the site of application by salt brine electrolysis as mixed oxidant solution (MOS) and applied for teat disinfection at initial FAC concentration of 1,500-1,600 mg per liter (ppm).

The pre-milking teat sanitizer (“pre-dip”) contains a detergent (sodium lauryl sulfate), therefore detergent neutralizer is applied in the microbiocidal efficacy tests to halt detergent activity. The post-milking teat sanitizer (“post-dip”) contains a non-toxic non-Newtonian colloidal compound and an emollient complex of lanolin with polyethylene glycol (lanolin-PEG75; for teat skin protection). Due to its oxidant demand (mostly from the PEG75 moiety) the free chlorine in the post-dip mixture is gradually quenched within several hours. The test for microbiocidal activity needs to be conducted in the presence of such “background” oxidant demand, yet needs to prove the required disinfection efficacy. In addition, both the pre-dip and post-dip mixtures contain a water-soluble dye. Two experimental blue dye compounds have been investigated in these tests for solubility, color and colloidal stability and as additives in the microbiocidal performance assays. An objective of the evaluation was to demonstrate a 5 log (100,000) kill of E. coli and S. aureus, representing Gram negative and Gram positive bacteria, within 30 seconds contact time. Inoculation levels should be between 80 and 120×10⁶ cells.

Materials.

Test organism—maintain E. coli ATCC 11229 and S. aureus 6358 on nutrient agar slant in refrigerator, transfer monthly. For test purposes, make daily transfers in nutrient agar slants for at least 3 days consecutive (<30 days total). Note that one-day interruption in consecutive daily transfers is acceptable. Note daily transfers on lab sheet.

Nutrient Agar Slants—for daily transfer of culture—Water Micro Lab. Supplies.

Sterile Phosphate Buffer dilutions (dilutions for determining initial counts)—Water Micro Lab. Supplies—99 mL blanks.

Phosphate Buffer Stock 0.25M (additive to other media): KH2PO4—34.0 g. Water—500 mL. pH 7.2 adjusted with 1N NaOH.

Detergent neutralizer (an emulsifier mixture used to halt detergent activity—used in microbiocidal performance tests of the pre-dip sanitizer): Azolectin—4 g. Tween 80—28 mL. Phosphate buffer stock—125 μL. Water—bring final volume to 100 mL. pH—7.2. Dissolve Azolectin in water while heating & stirring. Then add Tween 80 and buffer before diluting and adjusting the volume to 100 mL with water. Adjust pH to 7.2, divide into 50 mL aliquots in 100-mL bottles, and autoclave for 20 minutes @ 121° C.

Neutralizer Blanks—(makes about 18 tubes): 170.0 mL water. 10.0 mL Neutralizer Stock. 2.5 mL 0.25 M phosphate buffer stock.

Subculture Media (agar for pour-plating post-inoculated sanitizer aliquots): Tryptone Glucose Extract (TGE)—1 L per label instructions. Neutralizer stock—25 mL. Bring to boil and distribute into shake flasks at about one half the volume of the container. Temper media to about 48° C. (specific temp. not posted in AOAC) prior to testing.

Synthetic Hard Water: Solution 1—Dissolve 31.74 g MgCl2 or 67.77 g MgCl2.6H20 and 73.99 g CaCl2 in deionized water and dilute to 1 L. Autoclave- or filter-sterilize. Store in refrigerator for up to 2 months. Solution 2—56.03 g NaHC03 in 1 L distilled water. Sterilize by filtration.

Procedure.

Test Cultures—E. coli and S. aureus are prepared according to guidelines stated previously.

Subculture Media—prepare according to directions (see above) and temper in 48° C. water bath. 1 L media is sufficient to test about 4 sanitizer products.

Neutralizer Blanks—dispense 9 mL in 20×150 mm tubes, cap, and autoclave 15 min. at 121° C.

Synthetic Hard Water (SHW)—Each ml of Solution #1 yields about 100 ppm of hardness when diluted to one liter in deionized water. Dispense the required amount of Soln. #1 (i.e. 6 ml for 600 ppm) in a 1-liter volumetric flask; add about half of the deionized water. Add 4 ml of solution #2 while swirling (solution #2 should appear ‘milky’ at first, and then dissipate). Dilute to 1 liter using deionized water. Titrate the prepared SHW for hardness (calculated as CaC0₃) the day of testing.

Test culture preparation—from the overnight liquid culture of either E. coli or S. aureus, collect a small amount using a sterile loop and release it into a tube containing sterile phosphate buffer. Vortex the mixture to homogeneity, and dilute to the #1 McFarland Standard comparator. Alternatively, a spectrophotometric method can be used.

Media Preparation—prepare subculture media and neutralizer blanks according to instructions. Temper to designated temperature.

Operating Technique—prepare sanitizer sample according to the manufacturer's instructions. The FAC concentration of freshly generated MOS is typically in the range between 4,500-5,400 ppm. Dilute—if needed—the MOS to 4,500 ppm. Use 500 ppm SHW to make dilutions of the sanitizer samples.

Procedure swirl sanitizer sample before adding 1 mL inoculant at time t=0. Place inoculants stream somewhere between center of vortex and side of glass container, so that maximum mixing occurs upon introduction. Gently agitate during contact holding time. At 30 seconds, transfer 1 mL of the sample to a neutralizer blank, and vortex. 1.0 mL aliquots from the neutralizer blanks are deposited into each of 3 Aerobic Petrifilm (3M) count plates, which contain adequate amount of dry subculture medium. The plates are incubated at 36° C. for 24-48 hours. Following incubation, the colonies on Petrifilm plates are counted and averaged, and % (or log 10) reduction is determined.

Test Sanitizer Mixtures for Teat Disinfection Pre- and Post Milking

Mixing Protocol for Post-Dip Mixture:

1. Prepare 1% stock solution of water-soluble blue dye FD&C Blue No. 1 (or Orcozine Methylene Blue B2).

2. Prepare 20% stock solution of PEG75-lanoline in water. Mix gently overnight.

3. Prepare 2.5-3% colloidal solution of Laponite RD. Mix continuously for at least 20 min.

4. Post-Dip Component A (for 1 gallon total volume), mix the following:

a. 0.5 gallon Laponite RD solution

b. 0.1 gallon PEG75-lanolin solution

c. 0.1 gallon FD&C Blue No. 1 dye (or 0.05 gallon Orcozine Methylene Blue B2)

Total: 0.7 gallon

5. Post-Dip Component B:

0.3 gallon Chlorine-based Mixed Oxidant Solution (MOS) generated in on-site oxidant generator (initial FAC concentration should be between 4500-5000 ppm).

6. Mix Components A and B before use.

Final post-dip component concentrations:

1. FDF&C Blue No. 1 dye—0.1%

2. PEG75-lanolin (emollient)—2.0%

3. Laponite RD—1.25%-1.5% (to be determined at the site of application)

4. Free chlorine—1500-1700 ppm FAC.

Mixing Protocol for Pre-Dip Solution:

1. Prepare 2% stock solution of sodium lauryl sulfate (sodium dodecyl sulfate; SDS)

2. Prepare 1% stock solution of water-soluble blue dye FD&C Blue No. 1 (or Orcozine Methylene Blue B2).

3. Mixing protocol (for 1 gallon total volume):

a. Component A:

b. Water—0.5 gallon

c. 2% SDS—0.05 gallon

d. FD&C Blue No. 1 dye stock—0.1 gallon

(alternatively: Orcozine Methylene Blue B2 dye stock: 0.05 gallon)

Component A is stable for a long period; can be stored and transported.

e. Component B: 0.3 gallon Chlorine-based Mixed Oxidant Solution (MOS) generated in on-site oxidant generator (initial FAC concentration should be between 4500-5000 ppm).

4. Mix Components A and B before use.

Test Results:

The test protocol demonstrated 6-log inactivation of the target microorganisms within 30 seconds of contact time with the disinfectant mixtures in the presence of 10% reconstituted milk.

Conclusions:

Both example formulations of the pre- and post dip mixtures exhibit improved features compared to the previous formulations:

1. Fewer numbers of components and ease of handling and mixing.

2. Fully water-soluble components

3. Powerful teat disinfectants

4. Less expensive formulation with readily available components.

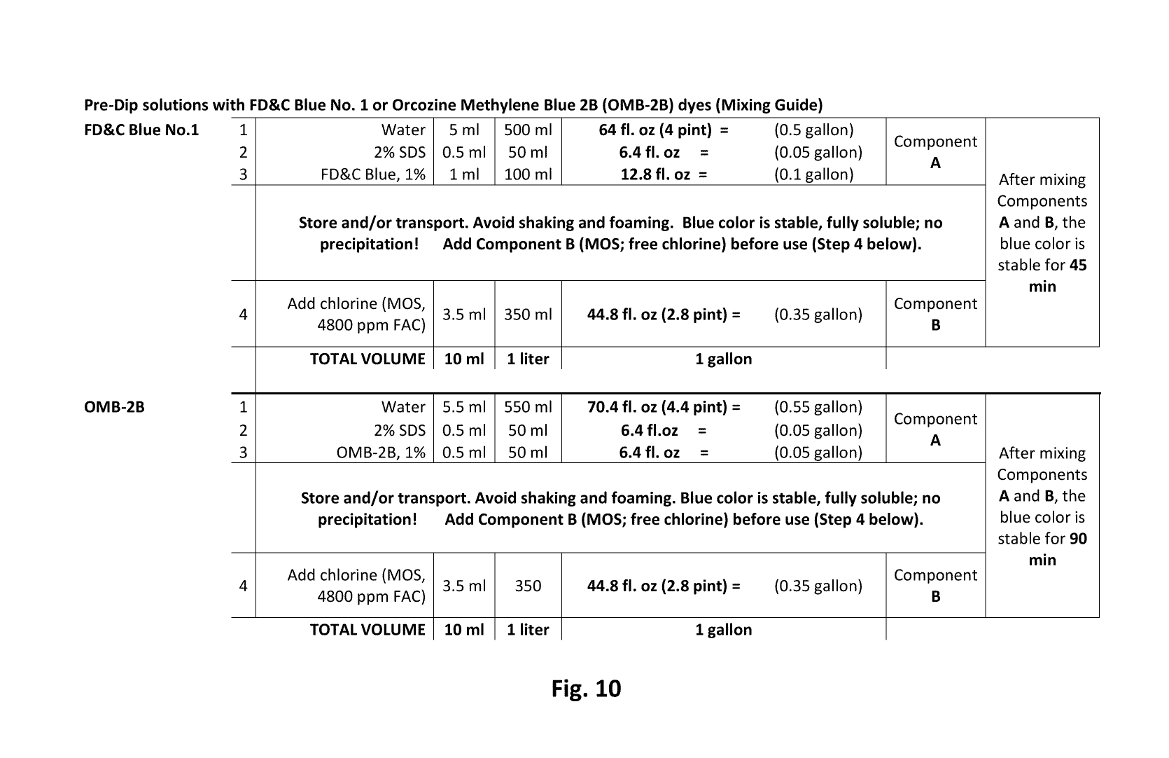

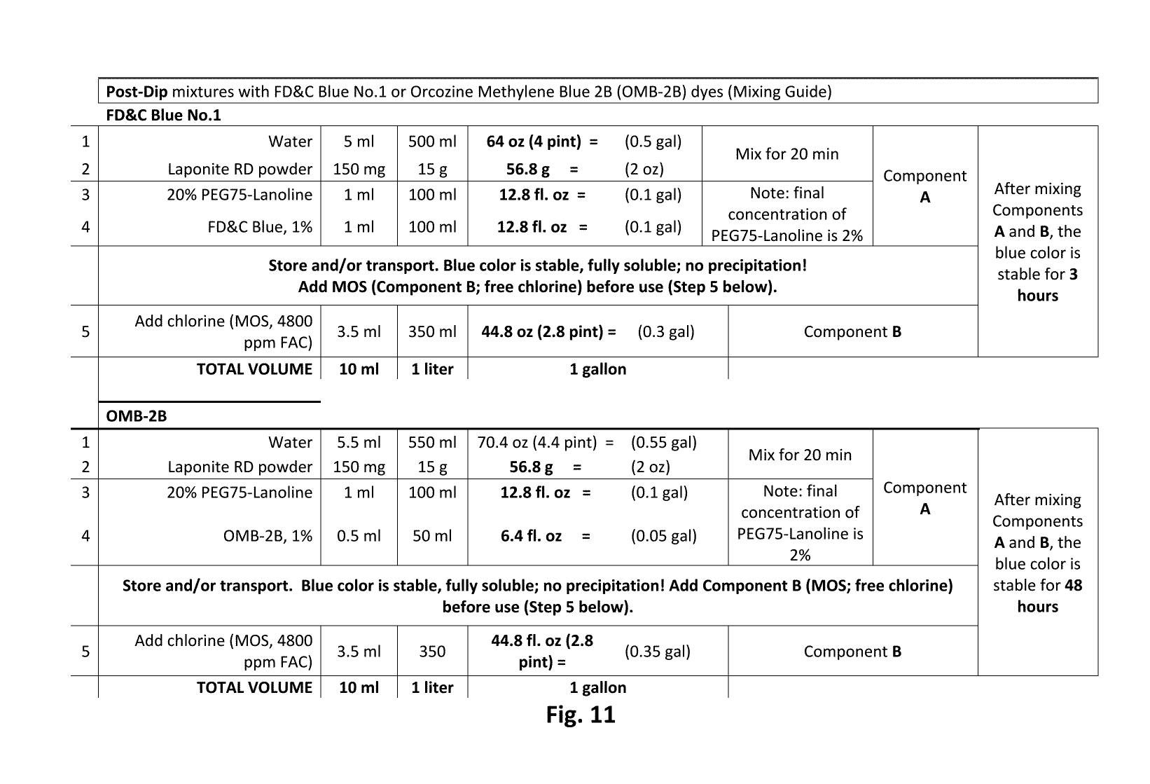

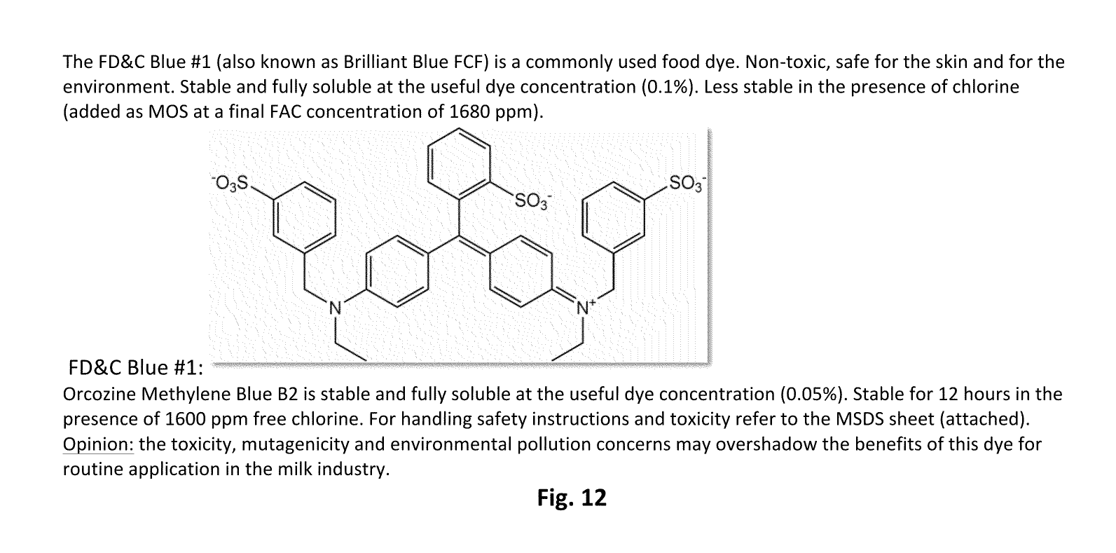

The preparation of the example embodiment is illustrated in FIGS. 10-12. FIG. 10 is a mixing guide for Pre-Dip solutions with FD&C Blue No. 1 or Orcozine Methylene Blue 2B (OMB-2B) dyes. FIG. 11 is a mixing guide for Post-Dip mixtures with FD&C Blue No. 1 or Orcozine Methylene Blue 2B (OMB-2B) dyes. FIG. 12 presents information and structure relative to the mixed solutions.

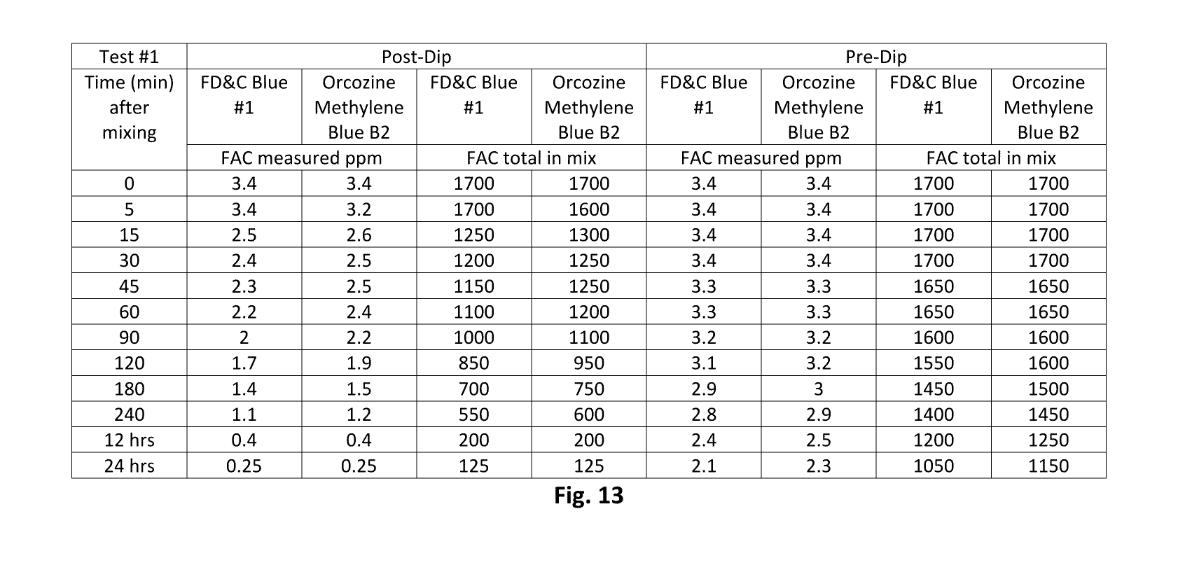

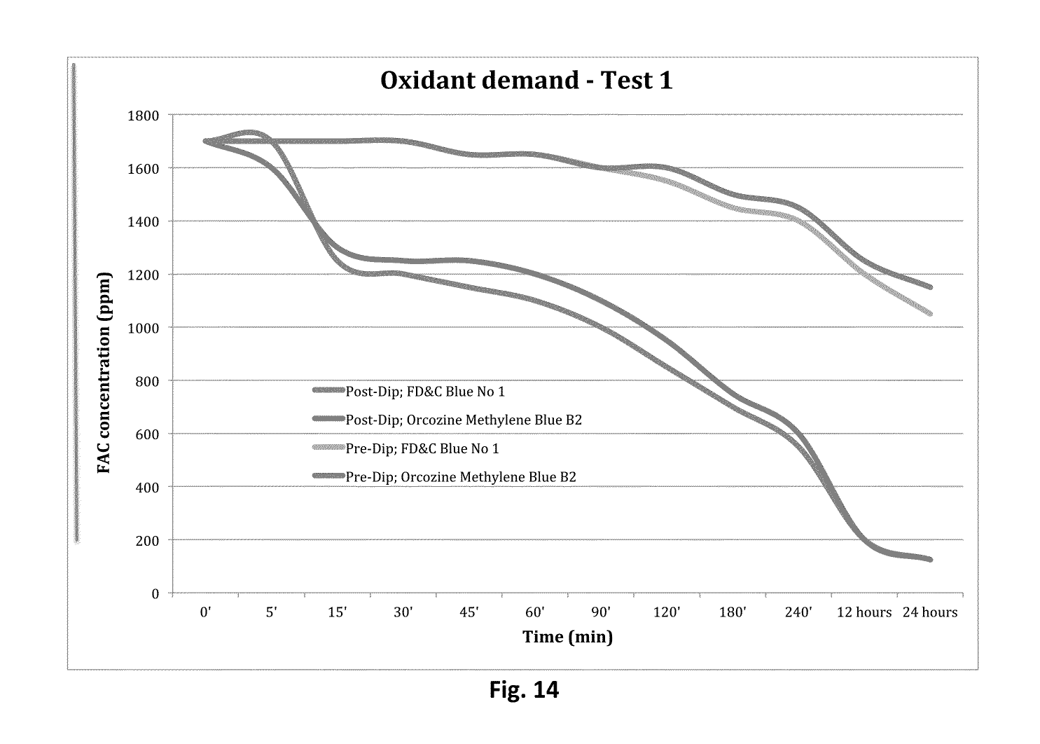

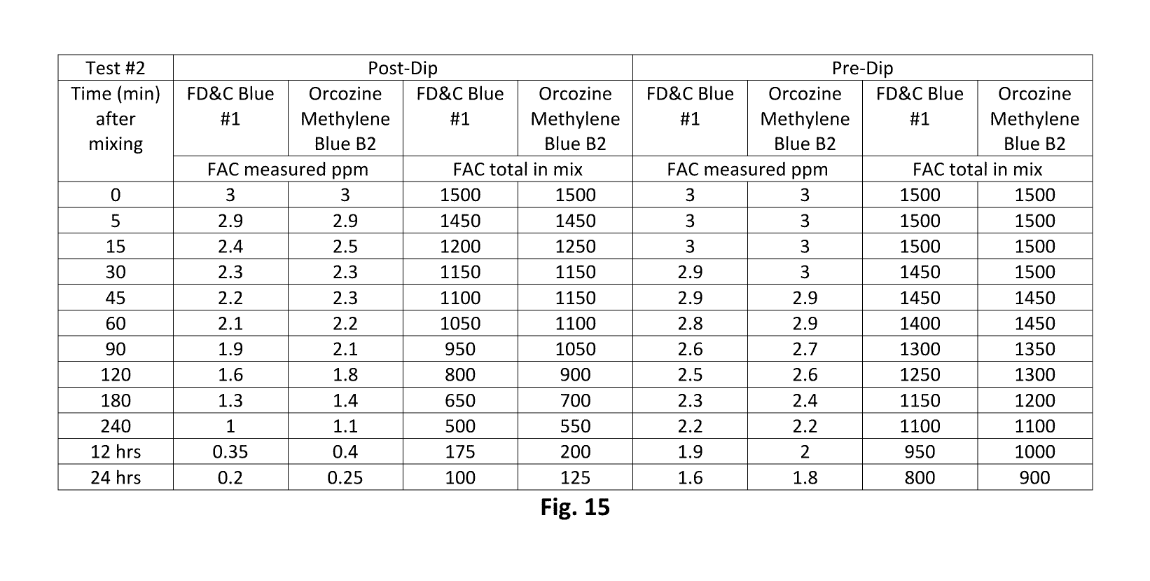

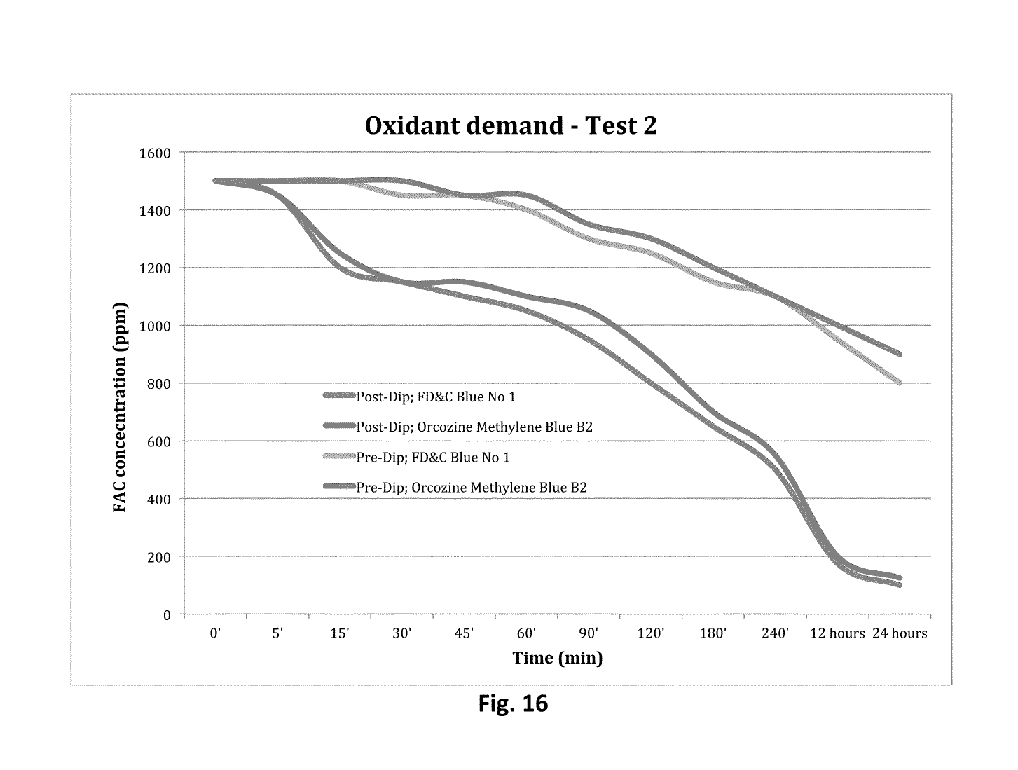

The assessment of oxidant demand is illustrated in FIGS. 13-16, at a recorded temperature of 18.6° C.

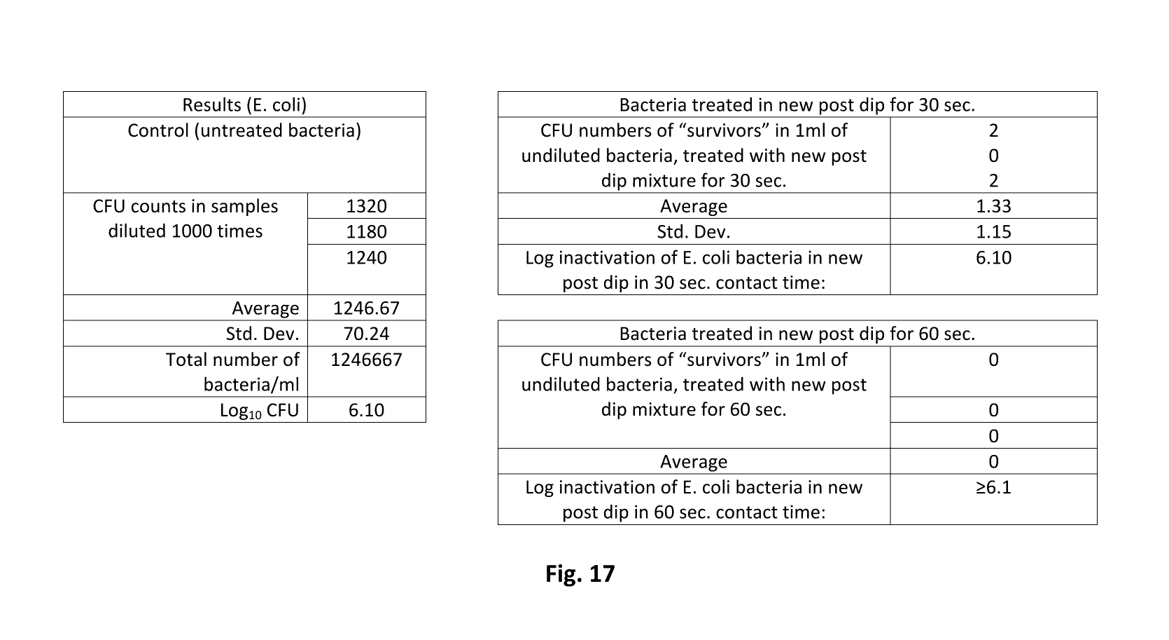

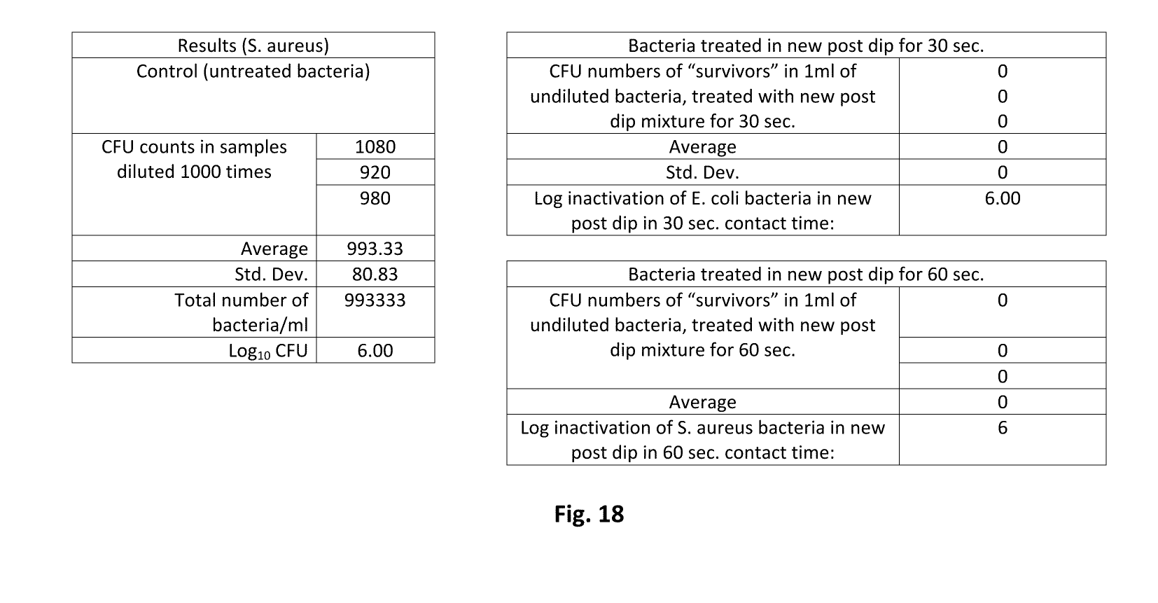

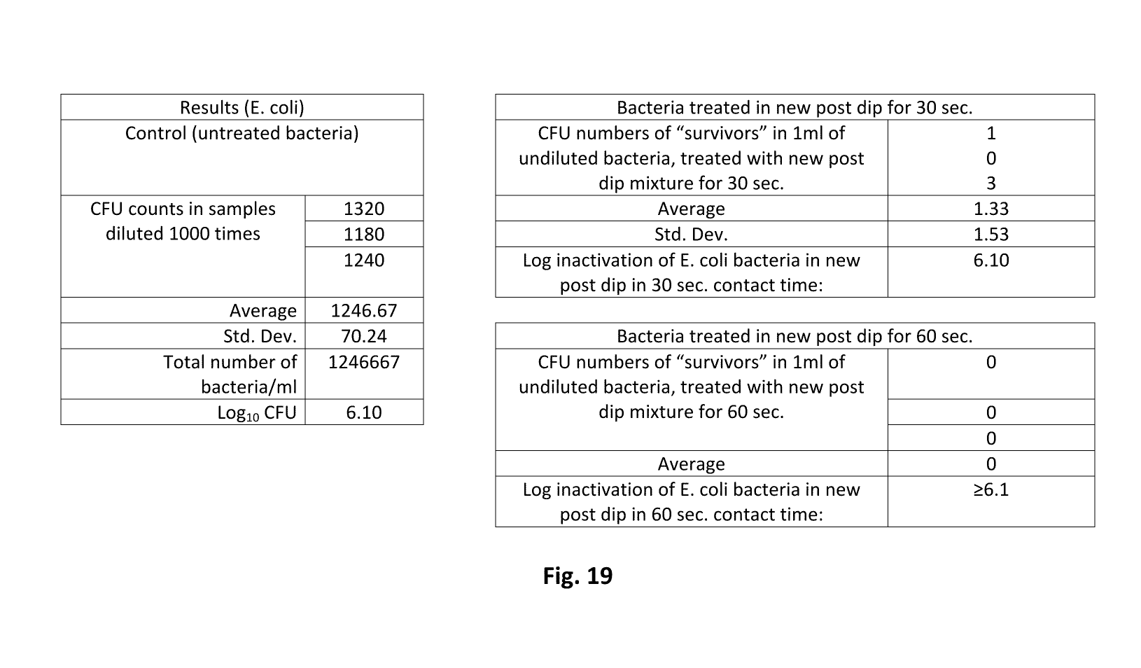

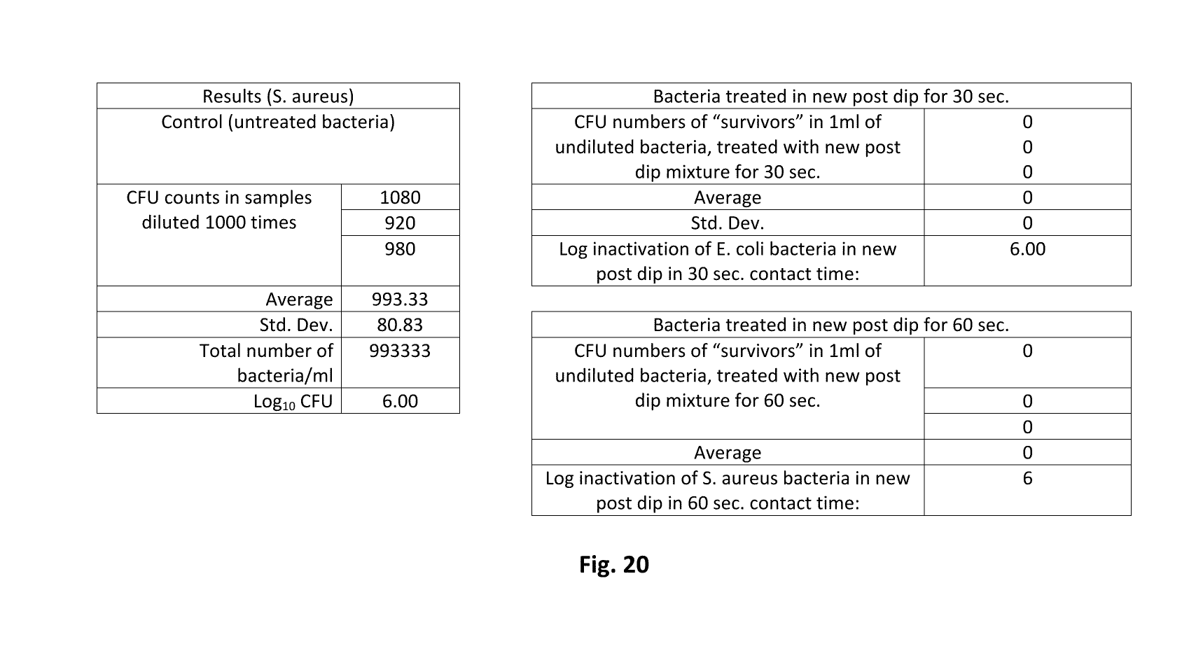

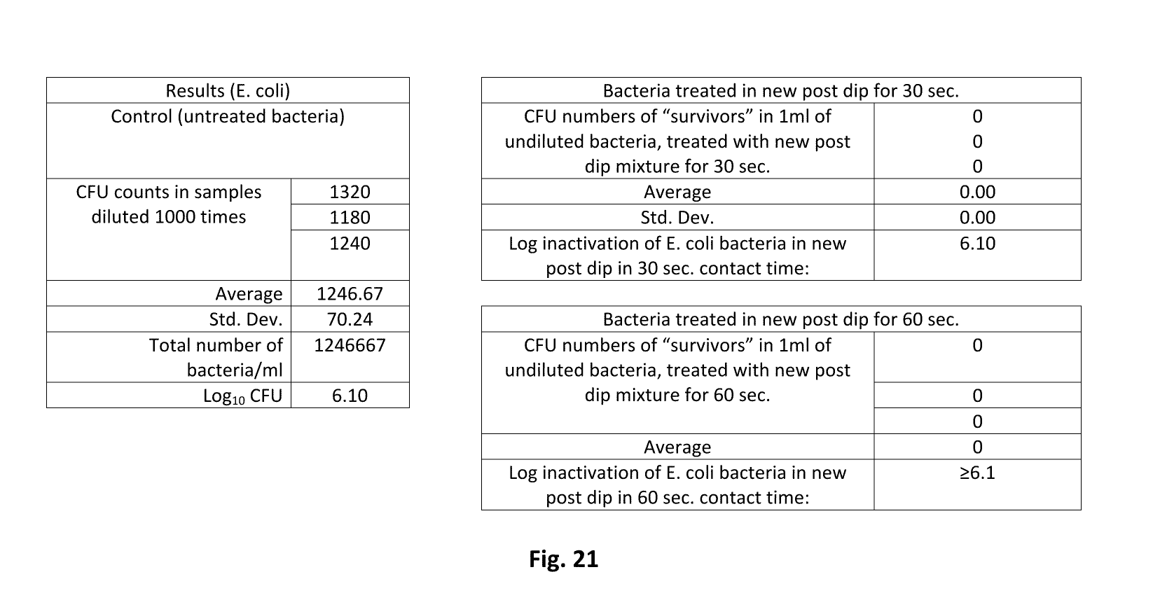

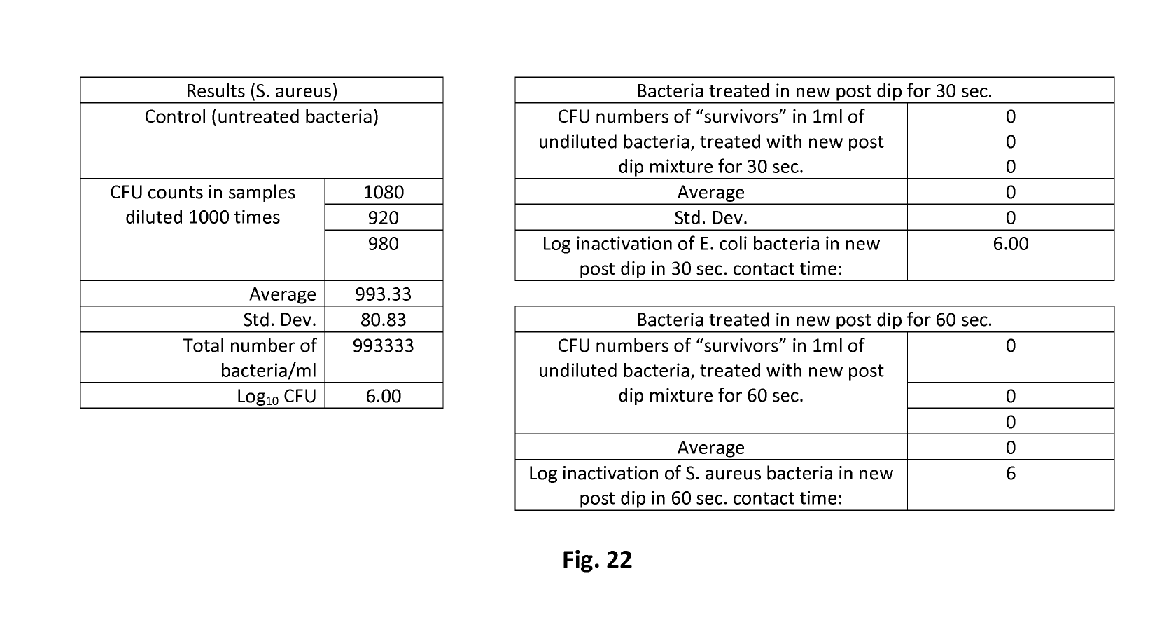

The bacteriocide performance is illustrated in FIGS. 17-22. FIG. 17 presents the results for E. coli in a Bactericide Activity Test for the New Post Dip formulation containing 2% PEG75-lanolin and FD&C Blue No. 1 dye. The New Post Dip formulation is a powerful bactericide: 6.1 log inactivation (“kill”) of Escherichia coli was demonstrated for either 30 sec or 1 min contact time. FIG. 18 presents the results for S. aureus in a Bactericide Activity Test for the New Post Dip formulation containing 2% PEG75-lanolin and FD&C Blue No. 1 dye. 6.0 log inactivation (“kill”) of Staphylococcus aureus was demonstrated for either 30 sec or 1 min contact time. FIG. 19 presents the results for E. coli in a Bactericide Activity Test for the New Post Dip formulation containing 2% PEG75-lanolin and Orcozine Methylene Blue B2. The New Post Dip formulation is a powerful bactericide: 6.1 log inactivation (“kill”) of Escherichia coli was demonstrated for either 30 sec or 1 min contact time. FIG. 20 presents the results for S. aureus in a Bactericide Activity Test for the New Post Dip formulation containing 2% PEG75-lanolin and Orcozine Methylene Blue B2. 6.0 log inactivation (“kill”) of Staphylococcus aureus was demonstrated for either 30 sec or 1 min contact time. FIG. 21 presents the results for E. coli in a Bactericide Activity Test for the New Pre Dip formulation. The New Pre-Dip formulation is a powerful bactericide: 6.1 log inactivation (“kill”) of Escherichia coli was demonstrated for either 30 sec or 1 min contact time. FIG. 22 presents the results for S. aureus in a Bactericide Activity Test for the New Pre Dip formulation. 6.0 log inactivation (“kill”) of Staphylococcus aureus was demonstrated for either 30 sec or 1 min contact time. The bacteriocide assessment was performed as set forth below.

Reagents:

Post-Dip: Water, Laponite RD, PEG75-lanolin, FD&C Blue No. 1, Orcozine Methylene Blue B2, free chlorine as mixed oxidant solution.

Pre-Dip: Water, sodium dodecyl sulfate (=sodium lauryl sulfate), FD&C Blue No. 1, Orcozine Methylene Blue B2, free chlorine as mixed oxidant solution.

Bacterium and growth medium: E. coli cultured in LB broth (LB-agar was used for the source culture). S. aureus cultured in TS broth (TSB-agar was used for the source culture). Fresh mid-log-phase culture was prepared. Grow bacteria in liquid LB or TS medium to ^{˜}0.5 A600 (^{˜}5×108 cells per mL).

Before conducting the tests, any remaining growth medium from the bacterial suspension was removed and replaced with 0.85 M saline by three cycles of centrifugation-resuspension. This step is essential to get rid of the massive oxidant demand of the nutrient media used to grow the bacteria.

The bactericide test medium was mixed according to the MIXING protocol for post dip mixture, which also contained 2% PEG75-lanolin. The chlorine component was added and mixed in 1 min before the actual test start.

In 50-ml capped tubes, 9 ml of this mixture was added to 1 ml of bacteria (107 bacteria suspended in 10% milk). After 30-sec (1-min) contact time, the residual free chlorine was quenched with sodium thiosulfate (1 mL of 1% thiosulfate added).

From this mixture 1 ml was applied onto Petrifilm sheets (corresponding to 106 bacteria). Three repeats were used.

Note: the number of E. coli cells was calculated from light absorbance readings at 600 nm. The cells were grown in liquid cultures to a density of 0.5 A600 unit, which corresponds to approximately 5×108 bacteria (colony forming units; CFU) per ml. The actual cell numbers were counted from dilution series of the untreated control samples from the bactericide tests.

Example Embodiment Incorporating Spray Gun Application.

The properties of the liquid chemical components to be used in a chlorine oxidant based teat post-dip, accommodate the use of spray gun (commercial or specifically designed for this application) for the mixing and delivery of the disinfectant. Such spray gun can have a dual channel for liquid inflow, and can use impingement-mixing technology to mix the chemicals in a designated chamber inside the gun. As an example, a suitable disinfectant can be formed and applied according to the following. Note that other formulations can be suitable for use with the spray gun application technique described in this example embodiment.

Component 1, comprising (a) and (b) (described below) can be prepared separately, e.g., mixed in a container, and the mixture delivered into channel 1 of a pump or spray gun. (a) comprises 1 volume of Laponite RD gel, 1.2-2% concentration (TBD in laboratory tests)—a colloidal, pseudo viscous fluid. Its shear-thinning property facilitates ease handling, mixing and pumping of the liquid. (b) comprises 1 volume of Lanoline (4-8%) emulsified in water-glycerin solution by appropriate mixing techniques. The concentration of glycerin can vary between 20% and 80% depending on the end-user's requirements.

Component 2 comprises chlorine-based mixed oxidant solution (MOS), generated at the site of application (or at a designated mixing station), and diluted with water as required to obtain MOS in a concentration range of 1000-4000 ppm free available chlorine (FAC). Component 2 can be delivered via channel 2 of the pump or spray gun's mixing chamber in a volume ratio approximately equal to the volume of Component 1. Note: the volume ratio of Components 1 and 2 can be controlled as required.

The final concentration of the mixture's components, when delivered into the teat dip, will be as follows: Laponite RD—0.6-1%; Lanoline—1-2%; Glycerin—5-20%; Free Available Chlorine—500-2000 ppm. Note: Both components 1 and 2 are liquids. Upon mixing, the Laponite RD colloid “hardens” in the presence of chlorine and generates a thicker non-newtonean colloid, which remains as a gel on the surface of the treated teat skin for several hours.

The example embodiment has several advantages over other approaches. As examples, it requires lesser quantities of Laponite RD compared to “direct” mixing of the components in containers before teat dip application; potential syneresis (“collapsing”) of the colloid into a liquid form is totally eliminated, and loss of FAC by the oxidant demand of other components upon storage is minimized to virtually zero.

With the present invention, all of the constituents can be delivered to the dairy as powders or solids. Mixed oxidants uses water, power and salt. The salt is the only logistics commodity for mixed oxidants. Water is available on a dairy as well as power. So, from a chemical delivery standpoint, salt is a safe and low cost dry chemical as compared to hazardous delivery of 12% bleach required for previous approaches. Note that 88% of commercial bleach is water. Laponite is a dry product that is mixed with water. Lanolin and glycerin can also be delivered as dry products. Surfactants such as sodium laurel sulfate can be delivered as a powder. Dyes can be delivered as powders. Generally speaking, chemical suppliers today are delivering to the dairy all of these chemicals as liquids. One of the advantages of the present invention is that it can dramatically reduce the bulk of delivered chemicals by just delivering dry chemicals to the dairy (up to 20 times less bulk) and using a blending station to make the appropriate chemical or mix of chemicals for that customer. With an automated blending station, the customer can dial in the appropriate chemical formula for conditions on the farm such as temperature, etc. By just delivering dry chemicals, chemicals can be delivered to the dairy once per quarter rather than once per week (current practice). This can dramatically reduce the cost for the distributor or chemical supplier.

The present invention has been described as set forth herein in relation to various example embodiments and design considerations. It will be understood that the above description is merely illustrative of the applications of the principles of the present invention, the scope of which is to be determined by the claims viewed in light of the specification. Other variants and modifications of the invention will be apparent to those of skill in the art.

What is claimed is:

1. An aqueous solution for application to teats of diary animals, comprising: (a) an emollient, (b) a gelling agent, a (c) a mixed oxidant disinfectant, and (d) an indicating agent.

2. A solution as in claim 1, wherein the gelling agent comprises a synthetic silica-based gelling agent

3. A solution as in claim 1, wherein the emollient comprises lanolin.

4. A solution as in claim 3, wherein the solution comprises about 1% to 10% lanolin.

5. A solution as in claim 4, wherein the solution comprises about 0.5% to 6% gelling agent, 0.01% to 0.3% mixed oxidant.

6. A solution as in claim 1, wherein the emollient comprises glycerol.

7. A solution as in claim 3, wherein the solution comprises about 5% to 50% glycerol.

8. A solution as in claim 7, wherein the solution comprises about 0.5% to 6% gelling agent, 0.01% to 0.3% mixed oxidant.

9. A solution as in claim 1, wherein the gelling agent comprises Si₈(Mg_{5.5}Li_{0.4})H₄O₂₄Na_{0.7}.

10. A solution as in claim 1, wherein the indicating agent comprises a dye.

11. A solution as in claim 1, wherein the emollient, gelling agent, and mixed oxidant disinfectant are combined such that the solution forms a non-Newtonian gel.

12. A method of preparing a solution as in claim 1, comprising: (a) mixing a gelling agent with water; (b) generating chlorine-based oxidant by salt brine electrolysis to produce a free chlorine solution; (c) adding an emollient.

13. A method as in claim 12, wherein the gelling agent comprises Si₈(Mg_{5.5}Li_{0.4})H₄O₂₄Na_{0.7}.

14. A method as in claim 12, wherein the emollient comprises lanolin.

15. A method as in claim 12, wherein the emollient comprises glycerol.

16. A method as in claim 12, wherein step (a) comprises mixing the gelling agent with water at a concentration of about 2 g of gelling agent per 90 mL of water.

17. A method as in claim 12, wherein step (c) comprises adding about 1 g of emollient per 100 mL of solution.

18. A method of applying a solution as in claim 1 to a teat of a dairy animal, comprising: (a) supplying a mixed oxidant to a mixing device using a first material channel; (b) supplying an emollient, an indicating agent, and a gelling agent to the mixing device using one or more material channels such that the oxidant does not react with the emollient prior to the mixing device; (c) combining the mixed oxidant, emollient, and gelling agent, and indicating agent in the mixing device; (d) expelling the combination from the mixing device directed toward the teat.

19. A method as in claim 18, wherein the gelling agent comprises Si₈(Mg_{5.5}Li_{0.4})H₄O₂₄Na_{0.7}.

20. A method as in claim 18, wherein the emollient comprises lanolin.

21. A method as in claim 18, wherein the emollient comprises glycerol.

22. A method as in claim 18, wherein the dye comprises FD&C Blue No. 1

23. A method as in claim 18, wherein the dye comprises Orcozine Methylene Blue B2

24. A method as in claim 1, wherein all of the chemicals are supplied in non liquid form.
